(19) United States
(12) Patent Application Publication
(10) Pub. No.: US 2016/0069361 A1
(43) Pub. Date: Mar. 10, 2016

(54) ANTI-KINK SYSTEM FOR MOVEABLE ELEMENT

(71) Applicant: Finn Alexander Strong, San Rafael, CA (US)

(72) Inventor: Finn Alexander Strong, San Rafael, CA (US)

(21) Appl. No.: 14/942,153

(22) Filed: Nov. 16, 2015

Related U.S. Application Data
(63) Continuation-in-part of application No. 14/589,865, filed on Jan. 5, 2015, now Pat. No. 9,215,914.
Application No. 14/589,865 is a continuation-in-part of application No. 14/304,875, filed on Jun. 13, 2014, now Pat. No. 8,926,394.
Application No. 14/304,875 is a continuation-in-part of application No. 13/860,516, filed on Apr. 10, 2013, now Pat. No. 8,926,392.
Application No. 13/860,516 is a continuation-in-part of application No. 13/772,316, filed on Feb. 20, 2013, now Pat. No. 8,505,116.
Application No. 13/772,316 is a continuation-in-part of application No. 13/588,035, filed on Aug. 17, 2012, now Pat. No. 8,752,308.
Application No. 13/588,035 is a continuation of application No. 13/333,462, filed on Dec. 21, 2011, now Pat. No. 8,266,828.
Application No. 13/860,516 is a continuation-in-part of application No. 13/588,035, filed on Aug. 17, 2012, now Pat. No. 8,752,308.
Application No. 14/304,875 is a continuation-in-part of application No. 13/588,035, filed on Aug. 17, 2012, now Pat. No. 8,752,308.
(60) Provisional application No. 61/528,100, filed on Aug. 26, 2011.
(60) Provisional application No. 61/429,177, filed on Jan. 2, 2011.

(51) Int. Cl. F15B 15/10

(52) U.S. Cl. CPC F15B 15/10

(57) ABSTRACT

A system and method for improving reliability and decreasing costs of an air-actuator assembly. The assembly may incorporate one or more performance improvements such as integrated conduits and active elements, ribbed portions on all or portions of conduits (e.g., where sharp bends are pathed) or coupling of a conduit to an active element (e.g., at an inlet/outlet port of a fluid reservoir), and/or use of one or more strategic side seams to help position and secure a desired routing and bending of conduit portions.

### CROSS REFERENCE TO RELATED APPLICATIONS

This Application is a Continuation-in-part of application Ser. No. 14/589,865 filed on January 5, 2015. application Ser. No. 14/589,865 is a Continuation-in-part of application Ser. No. 14/304,875 filed on Jun. 13, 2014. application Ser. No. 14/304,875 is a Continuation-in-part of application Ser. No. 13/860,516 filed on Apr. 10, 2013. application Ser. No. 13/860,516 is a Continuation-in-part of application Ser. No. 13/772,316 filed on Feb. 20, 2013. application Ser. No. 13/772,316 is a Continuation-in-part of application Ser. No. 13/588,035 filed on Aug. 17, 2012. application Ser. No. 13/588,035 is a Continuation of application Ser. No. 13/333,462 filed on Dec. 21, 2011. application Ser. No. 13/333,462 claims the benefit of U.S. Provisional Application No. 61/528,100 filed on Aug. 26, 2011. application Ser. No. 13/333,462 claims the benefit of U.S. Provisional Application No. 61/429,177 filed on Jan. 2, 2011. application Ser. No. 13/860,516 is a Continuation-in-part of application Ser. No. 13/588,035 filed on Aug. 17, 2012. application Ser. No. 14/304,875 is a Continuation-in-part of application Ser. No. 13/588,035 filed on Aug. 17, 2012. The contents of these applications are hereby expressly incorporated by reference thereto in their entireties for all purposes.

### FIELD OF THE INVENTION

The present invention relates generally to communication channels for pneumatic actuators, and more specifically, but not exclusively, to flexible conduits for air-powered actuators used in amusement systems for children.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The incorporated patent applications include a number of descriptions of amusement systems designed for use by children. Many of these systems include an assembly including an air bladder communicated to one or more air-powered actuators using a flexible plastic hose.

Acquisition and acceptance of these amusement systems is at least partially influenced by reliability and cost. Cost is usually directly related to a number of components in the assembly with reliability usually inversely related to the number. To decrease cost and improve reliability, use of fewer components is preferred. For example, some solutions may include a bladder, a pair of actuators, a “T” junction, and three segments of hose to connect the bladder and the actuators to the junction. This identifies a total of six elements that are manufactured, inspected, shipped, and assembled.

Another factor influencing cost and reliability for amusement systems designed for children, particularly amusement systems that are provided as part of footwear, is that often very short lengths of hose are desired to be used (to decrease costs). Whatever the length of hose, it is common for hose pathing to include a number of sharp turns when extending from one component of the assembly to another. A sharp turn in a hose segment often causes a restriction in air flow through that hose segment which degrades the performance of the assembly. The extent of the degradation is related to a magnitude of restriction which in some instances may result in a total blockage of air flow. As the hose lengths become shorter, tighter bends may become more prevalent.

What is needed is a system and method for improving reliability and decreasing costs of an air-actuator assembly.

### BRIEF SUMMARY OF THE INVENTION

Disclosed is a system and method for improving reliability and decreasing costs of an air-actuator assembly. The following summary of the invention is provided to facilitate an understanding of some of the technical features related to improvements (e.g., anti-kinking and component count reduction) in air-actuator assemblies such that may be deployed in an amusement system, particularly those designed for use by children, and is not intended to be a full description of the present invention. A full appreciation of the various aspects of the invention can be gained by taking the entire specification, claims, drawings, and abstract as a whole. The present invention is applicable to other applications in addition to amusement systems, as well as applicable to amusement systems including other articles of clothing in addition to footwear, including hats, backpacks, and other amusement systems that do not include clothing, such as containers, pouches, plush figurines, and the like that may be carried and/or manipulated by a user.

An embodiment of the present invention for a fluid-controlled actuator assembly may include a reduced component count by integrating a conduit with a fluid reservoir and/or an actuator included as part of the assembly. The conduits may be joined together using an optional junction to intercouple all the air channels of the joined conduit. This integration is performed at the manufacturing stage (e.g., molding process) and does not require a connector to physically join an end of a conduit to its corresponding active element, and therefore does not require separate inventory management of conduits separate from active elements, use of connectors, or an assembly step (manual and/or robotic) to assemble/integrate a conduit to its associated active element.

An embodiment of the present invention may provide enhanced performance and/or reduced performance degradation that could arise from sharp bends in conduit portions or other locations where large compressive forces may exist that could pinch closed a conventional conduit or active element of the actuator assembly. Providing ribbed portions along all or portions of the elements (e.g., sharp bends, conduit-bladder coupling, or the like) resists performance degrading pinching of the conduits at these locations.

An embodiment of the present invention may provide for a directional pathing bias by use of a molding process and subsequent routing of conduits during installation, to produce one or more seams in exterior side walls of some or all of the conduit portions.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

A fluid-controlled actuator assembly includes an actuating element including a first exterior side wall defining both a repeatably collapsible fluid reservoir and a first integrated elongate conduit having a first air channel therethrough; and an actuator element including a second exterior side wall defining both a repeatably operable actuator and a second integrated elongate conduit having a second air channel therethrough; wherein the conduits are coupled together; and wherein the air channels are coupled together.

A fluid-controlled actuator assembly includes an actuating element including a first exterior side wall defining a repeatably collapsible fluid reservoir and a first port; a first elongate conduit having a first end coupled to the first port, a second end opposite from the first end, and a first conduit side wall defining a first air channel extending from the first end to the second end; an actuator element including a second exterior side wall defining a repeatably operable actuator and a second port; and a second elongate conduit having a third end coupled to the second port, a fourth end opposite from the third end, and a second conduit side wall defining a second air channel extending from the third end to the fourth end; wherein the second end is coupled to the fourth end; and wherein a portion of at least one conduit side wall includes a ribbed portion.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1-FIG. 3 illustrate a typical plastic hose that may be used in an air-actuator assembly;

FIG. 1 illustrates the hose shaped to include a sharp turn creating a flow-restricting kink;

FIG. 2 illustrates a side view of the hose illustrated in FIG. 1; and

FIG. 3 illustrates a sectional view of the kink in which an internal fluid channel is completely closed at a location of the kink;

FIG. 4 illustrates an amusement system including an air-actuator assembly including a reduced number of components that employ anti-kink conduits;

FIG. 5-FIG. 7 illustrate an anti-kink conduit that may be used in the assembly of FIG. 4;

FIG. 5 illustrates the conduit shaped to include a sharp turn inhibiting a creation of a flow-restricting kink;

FIG. 6 illustrates a side view of the conduit illustrated in FIG. 5;

FIG. 7 illustrates a sectional view of the sharp bend in which an internal fluid channel is inhibited from becoming completely closed at a location of the sharp bend; and

FIG. 8 illustrates an amusement system including a plush figurine including an air-actuator assembly.

### DETAILED DESCRIPTION OF THE INVENTION

Embodiments of the present invention provide a system and method for improving reliability and decreasing costs of an air-actuator assembly. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### Definitions

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to some embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

As used herein, the terms “ribbed portion” and “ribbed portions” mean a structure including a collapsible wall surrounding a fluid channel, cavity, reservoir, bladder, void, or the like such that all or a portion of the collapsible wall includes a series of discrete periodic diameter changes along the length of the air channel, preferably with a series of uniform small and larger diameters evenly spaced apart.

As used herein, the term “size” refers to a characteristic dimension of an object. Thus, for example, a size of an object that is spherical can refer to a diameter of the object. In the case of an object that is non-spherical, a size of the non-spherical object can refer to a diameter of a corresponding spherical object, where the corresponding spherical object exhibits or has a particular set of derivable or measurable properties that are substantially the same as those of the non-spherical object. Thus, for example, a size of a non-spherical object can refer to a diameter of a corresponding spherical object that exhibits light scattering or other properties that are substantially the same as those of the non-spherical object. Alternatively, or in conjunction, a size of a non-spherical object can refer to an average of various orthogonal dimensions of the object. Thus, for example, a size of an object that is a spheroidal can refer to an average of a major axis and a minor axis of the object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

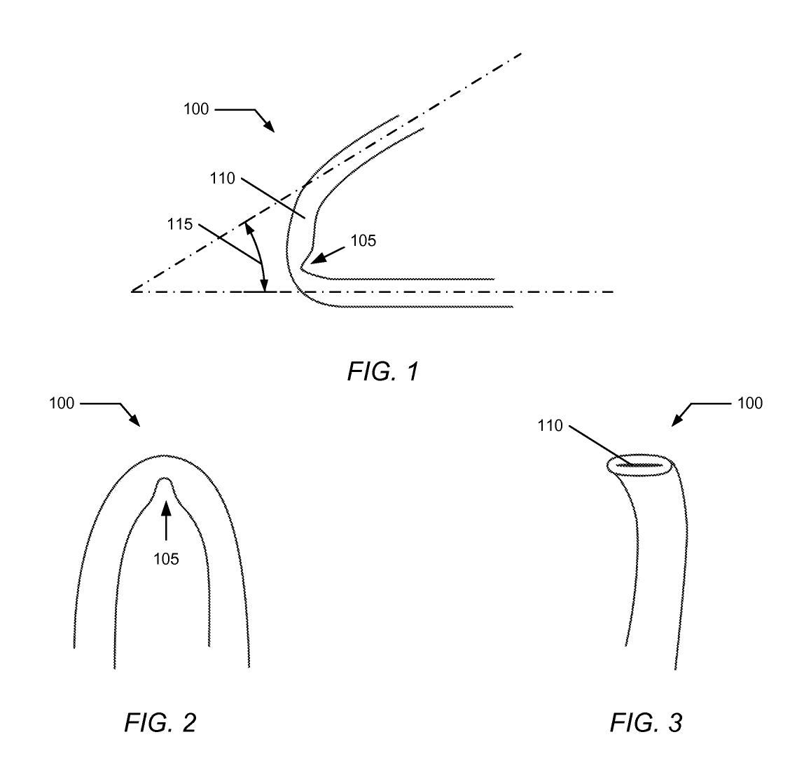

FIG. 1-FIG. 3 illustrate a typical plastic hose 100 that may be used in an air-actuator assembly; FIG. 1 illustrates hose 100 shaped to include a sharp turn creating a flow-restricting kink 105; FIG. 2 illustrates a side view of hose 100; and FIG. 3 illustrates a sectional view of kink 105 in which an internal fluid channel 110 of hose 100 is completely closed at a location of kink 105.

Hose 100 is illustrated having an bend angle 115 of about ninety degrees or less, and in some cases angle 115 may be about zero degrees. A material and construction of hose 100, including a thickness of a hose wall relative to a diameter of channel 110, influence at which angle(s) 115 hose 100 may begin to form kink 105.

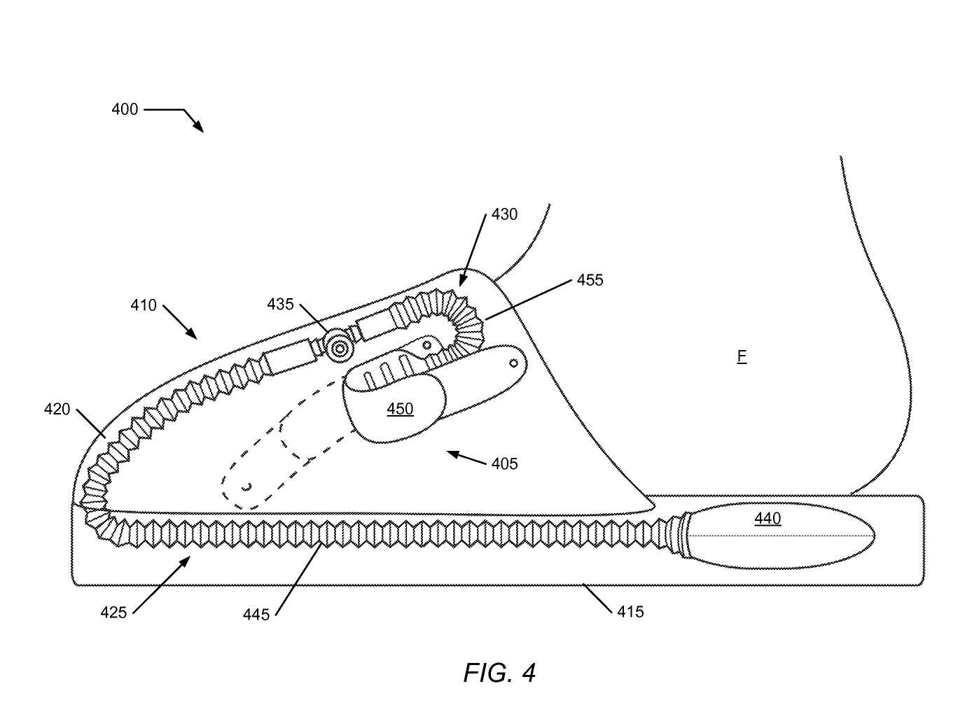

FIG. 4 illustrates an amusement system 400 including an air-actuator assembly 405 including a reduced number of components that employ anti-kink conduits. System 400 is provided as part of an article of clothing worn by a person, for example, a covering 410 (e.g., a shoe, slipper, bootie, flip-flop, sandal, boot, footwear, or the like) for a foot F of a child.

Covering 410 includes a sole 415 typically coupled to an upper 420 (though some coverings 410 may have an alternate construction). Assembly 405 may be integrated into sole 415 and upper 420.

Assembly 405 includes an actuating element 425 and one or more actuator elements 430 all coupled to a junction 435. Actuating element 425 includes a fluid reservoir 440 (e.g., a bladder or the like) positioned within sole 415, for example beneath a heel of foot F. Actuating element 425 further includes a length of conduit 445 integrated with reservoir 440. This is in contrast to systems in which a bladder is separate and distinct from a hose. The bladder is provided with a hose connector that is used to join the hose to the bladder and therefore has two or three discrete elements in contrast to the single element count of actuating element 425.

Each actuator element 430 includes an air-powered actuator 450, such as disclosed in one of the incorporated patent applications. For example, actuator 450 may include a folded, rolled, furled, closed, contracted, or otherwise shaped inflatable bladder formed of memory material (or provided with an external biasing structure) that unfolds, unrolls, unfurls, opens, expands, or otherwise transitions from a first mode to a second mode in response to one type of fluid pressure changes within assembly 405. The memory material or the biasing element returns, or helps to return, the inflatable bladder to the folded, rolled, furled, closed, contracted, or other shaped mode in response to another type of fluid pressure changes or other operating conditions. Actuator may include a first portion attached to covering 410 and thereby secured in place and a second portion that is free to move relative to covering 410. The second portion defines a moveable element to provide motion for system 400, such as for example, transitions of actuator 450 in synchronization with the child walking and repeatedly weighting and unweighting sole 415 which compresses and uncompresses reservoir 440.

Amusement system 400 may define a theme, for example a particular animal (e.g., a puppy) with the moveable element linked to the theme such as providing moving ears that rise and fall in synchronization with the transitions of actuator 450. To aid in the linking of actuator 450 into the theme, a sheath or other covering may overlie and conceal the second portion. The sheath may further include two viewing modes—such as one viewing mode presented to a third-party observer when actuator 450 is folded or the like and another viewing mode when actuator 450 is unfolded or the like. The second viewing mode may be hidden or otherwise concealed and revealed only when actuator 450 transitions from the folded mode to the unfolded mode. Apertures or other structural elements may be incorporated into actuator 450 for over-pressure protection as well as to allow a controlled transition to the folded/stable state even when reservoir 440 remains compressed.

Actuator element 430 further includes a length of conduit 455 integrated with actuator 450. This is in contrast to systems in which an air-actuator is separate and distinct from a hose. The actuator is provided with a hose connector that is used to join the hose to the actuator and therefore has two or three discrete elements in contrast to the single element count of each actuator element 430.

Optional junction 435 joins actuating element 425 to the one or more actuator elements 430 by coupling to the conduit portions of the other elements of assembly 405. The construction and operation of junction 435 is dependent upon the desired features. For a single actuator element 430 coupled to a single actuating element, these components may be integrated together with reservoir 440 and actuator 450 sharing a common integrated conduit.

Some implementations may desire or need a one-way air intake function in which a one-way valve may be incorporated into assembly 405, for example using junction 435. This one-way intake valve permits air from ambient to enter into one or more conduits when actuator(s) 450 is/are transitioning from the expanded mode to the contracted mode. Similarly, this one-way valve prevents or inhibits air from escaping from the intercoupled air channels of the conduits to ambient during transitions of actuator(s) 450 from the contracted mode to the expanded mode. As noted, some embodiments may be implemented with a stable contracted mode and a transitory expanded mode—assembly 405 in this configuration is designed to return actuator(s) 450 to the folded mode even when reservoir 440 remains compressed. For example, the bleed valve may be included in some component of assembly 405 as a one way fluid flow control to allow for such default transitions. In some embodiments, junction 435 may incorporate both rapid intake flow control from ambient and a slower bleed outflow function to ambient. In some embodiments, the flow control for intake and/or outflow may variable to be tuned during manufacture/assembly for a particular implementation.

When assembly 405 includes two or more actuator elements 430, junction 435 couples conduit 445 to each conduit 455 of each actuator element 430 and interconnects all the air channels of the intercoupled conduits. For this configuration, junction 435 may also include the one-way valving function as described herein and in the incorporated patent applications.

An alternative improvement to assembly 405 that may be used in lieu of, or in addition to the integration of conduit portions with reservoir 440 and/or actuator 450 is to provide one or more ribbed portions along all or portions of any conduit. In implementations including ribbed portions along selected portions of a conduit, some embodiments may provide a ribbed portion at locations where a conduit may have a tendency to kink or become pinched shut, such as, for example, at locations of sharp bends. The ribbed portions may not only resist degradation of air channel flow (e.g., kinking or pinching shut of a portion of the air channel) at sharp bends, but also at other non-sharp bend locations where there may be a compressive force applied to an outer wall tending to pinch shut a portion of an air communication channel. For example, a location where reservoir 440 transitions to conduit 445, which may be located under or near a heal of foot F, and reinforcement of a wall of conduit 445 only near reservoir 440 could result in air channel degradation due to a pinching shut/closure of an inlet/outlet portion of reservoir 440. Some embodiments of the present invention include extension of the ribbed portion onto the inlet/outlet portion (or more) of reservoir 440 to help resist non-sharp bend constriction that could lead to operational failure or perceptible degradation of assembly 405 and by extension, of amusement system 400.

There are many different manufacturing techniques for production of actuating element 425 or actuator element 430. For example, there are many different molding processes that may produce these elements from molded polymers/plastics. In some molding processes, a one or more seams may be present on the integrated conduits, bladders, and/or actuators. These side seams may impart a directional bias, particularly on the conduits which may produce a torque in an event that the conduit with such seams is bent in a non-preferential direction. Embodiments may take advantage of this directional bias in routing conduits during installation to help maintain conduits in desired locations and orientations.

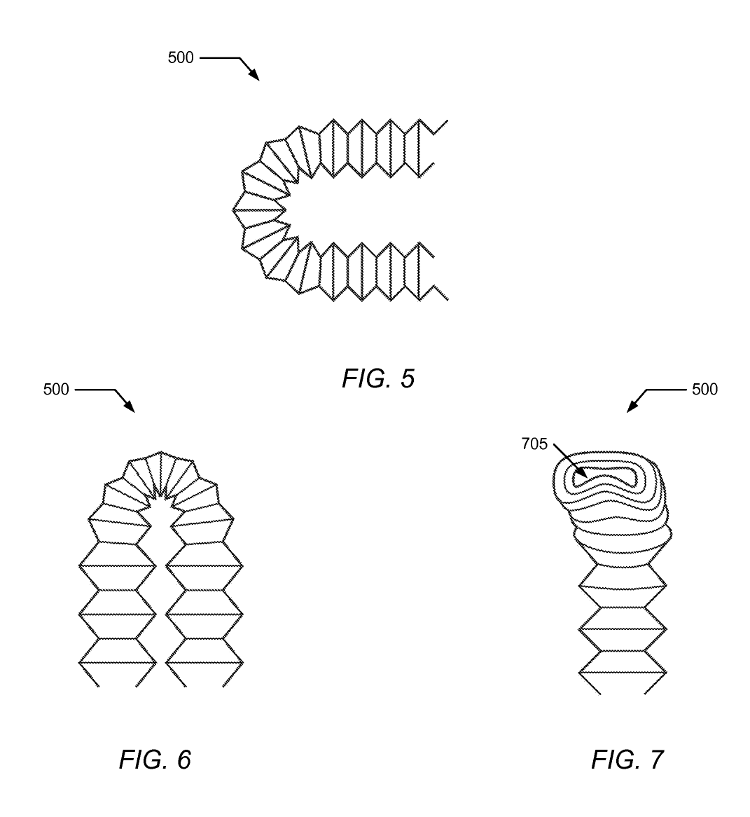

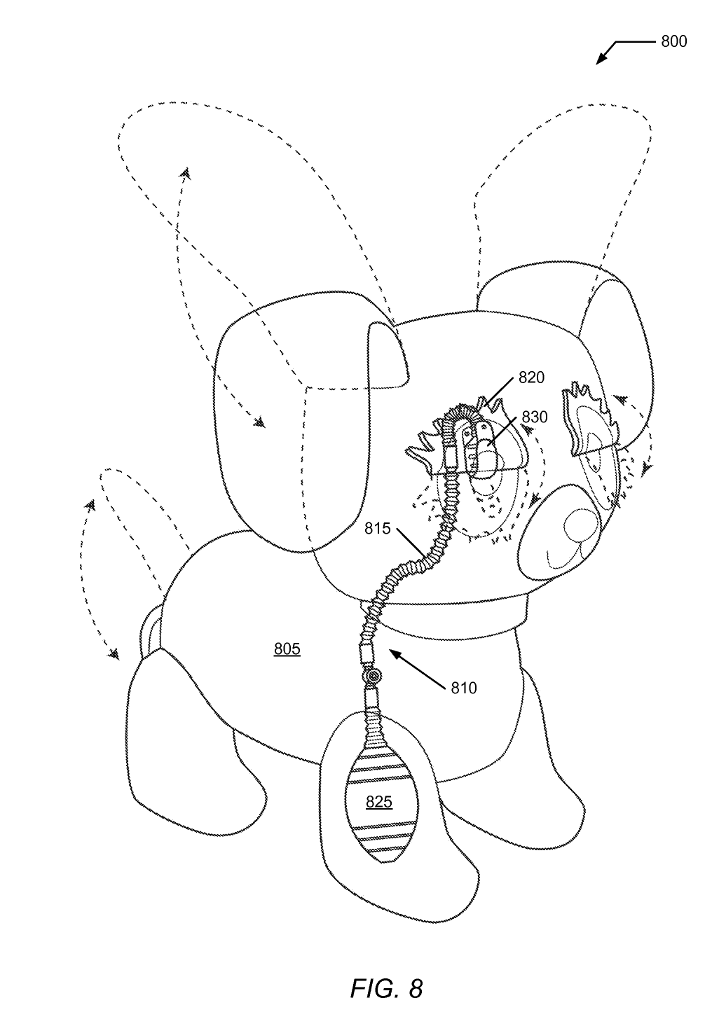

FIG. 5-FIG. 7 illustrate an anti-kink conduit 500 that may be used in all or portions of assembly 405 of FIG. 4 as discussed herein; FIG. 5 illustrates conduit 500 shaped to include a sharp turn while inhibiting a creation of a flow-restricting kink; FIG. 6 illustrates a side view of conduit 500; and FIG. 7 illustrates a sectional view of the sharp bend of FIG. 5 and FIG. 6 in which an internal fluid channel 705 is inhibited from becoming completely closed at a location of the sharp bend. The ribbed portions at a sharp bend have a tendency to produce one or more side channels that are difficult to close or pinch shut. The kink in FIG. 6 should be noted as being difficult to form in a conduit with one or more ribbed portion. This structure is strongly anti-kink. FIG. 7 illustrates that even in an unlikely event that a conduit may be induced to have a kink at a ribbed portion, such infrequent kinks rarely, if ever, completely restrict fluid flow through that portion because of the formation of the one or more side channels.

FIG. 8 illustrates an amusement system 800 including a plush figurine 805 including an air-actuator assembly 810. Amusement system 800 illustrates a benefit of use of a kink resistant ribbed hose 815. For example, in order to have an eye lid 820 transition from open when un-activated, to closed when air bladder 825 is squeezed, a flapper (e.g., actuator) 830 has to be in a reverse orientation as compared to many of the implementations in the incorporated patent application. Such a reverse orientation often requires a tight turn that would kink a normal hose shut, making such an amusement system in-operable and limiting options available to a manufacturer of amusement systems. Ribbed hose 815 allows for versatility and reliability for amusement system 800 allowing for kink-free tight turns without affecting air flow for a variety of applications. Ribbed hose 815 can also reduce parts in an amusement system because an option for an amusement system including sharp bends without ribbed hose 815 includes a use of hard plastic “L” connectors that must be used with normal hose to make tight turns. The use of additional hard plastic connectors increases component count and labor costs to assembly/connect connectors and hose segments.

In amusement system 800, bladder 825 is disposed in an appendage (e.g., a front paw of a thematic figurine) and actuator assembly 810 couples bladder 825 to flapper 830 to eye lid 820. When bladder 825 is squeezed, eye lid 820 responds and “blinks” to shut/conceal the eye. As noted in the incorporated applications, actuator assembly 810 may control one or more flappers from an operation of a single bladder (e.g., blink both eye lids). In other cases, there may be multiple bladders each controlling a different set of flappers, each set including one or more actuators. Bladders may be disposed in various appendages and/or body as needed or desired to control other components of the amusement system (e.g., other appendages (ears, tail, and the like and/or accessories of figurine 805 that are not appendages, such as collars, clothing, or other associated moveable element).

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A fluid-controlled actuator assembly, comprising:
an actuating element including a first exterior side wall defining both a repeatably collapsible fluid reservoir and a first integrated elongate conduit having a first air channel therethrough; and
an actuator element including a second exterior side wall defining both a repeatably operable actuator and a second integrated elongate conduit having a second air channel therethrough;
wherein said conduits are coupled together; and
wherein said air channels are coupled together.

2. The assembly of claim 1 further comprising a junction coupled to said conduits and intercoupling said air channels to produce a common air channel.

3. The assembly of claim 2 wherein said junction includes a one-way valve configured to resist venting of fluid from said common air channel to ambient while permitting influx of fluid from ambient into said common air channel.

4. The assembly of claim 2 wherein said junction includes a one-way valve configured to permit influx of fluid from ambient into said common air channel.

5. The assembly of claim 4 wherein said permitted influx of fluid occurs at a first volumetric flow rate through said one-way valve and wherein said junction further includes a bleed valve configured to permit outflux of fluid to ambient from said common air channel at a second volumetric flow rate through said bleed valve, said second volumetric flow rate less than said first volumetric flow rate.

6. The assembly of claim 1 wherein a portion of at least one side wall includes a ribbed portion.

7. The assembly of claim 6 wherein said portion of at least one side wall further defines a sharp bend at a junction of two adjacent segments of one of said conduits and wherein said ribbed portion extends to both said adjacent segments.

8. A fluid-controlled actuator assembly, comprising:
an actuating element including a first exterior side wall defining a repeatably collapsible fluid reservoir and a first port;
a first elongate conduit having a first end coupled to said first port, a second end opposite from said first end, and a first conduit side wall defining a first air channel extending from said first end to said second end;
an actuator element including a second exterior side wall defining a repeatably operable actuator and a second port; and
a second elongate conduit having a third end coupled to said second port, a fourth end opposite from said third end, and a second conduit side wall defining a second air channel extending from said third end to said fourth end;
wherein said second end is coupled to said fourth end; and
wherein a portion of at least one conduit side wall includes a ribbed portion.

9. The assembly of claim 8 further comprising a junction coupled to said conduits and intercoupling said air channels to produce a common air channel.

10. The assembly of claim 9 wherein said junction includes a one-way valve configured to resist venting of fluid from said common air channel to ambient while permitting influx of fluid from ambient into said common air channel.

11. The assembly of claim 9 wherein said junction includes a one-way valve configured to permit influx of fluid from ambient into said common air channel.

12. The assembly of claim 11 wherein said permitted influx of fluid occurs at a first volumetric flow rate through said one-way valve and wherein said junction further includes a bleed valve configured to permit outflux of fluid to ambient from said common air channel at a second volumetric flow rate through said bleed valve, said second volumetric flow rate less than said first volumetric flow rate.

13. The assembly of claim 8 wherein said portion of at least one conduit side wall further defines a sharp bend at a junction of two adjacent segments of one of said conduit side walls and wherein said ribbed portion extends to both said adjacent segments.

14. The assembly of claim 8 wherein said first elongate conduit is integrated with said actuating element such that said first air channel is coupled to said first port and wherein said second elongate conduit is integrated with said actuator element such that said second air channel is coupled to said first port.
